(19) United States
(12) Patent Application Publication
(10) Pub. No.: US 2022/0136824 A1
(43) Pub. Date: May 5, 2022

(54) DEVICE FOR CHASSIS MEASUREMENT AND METHOD FOR CHASSIS MEASUREMENT

(71) Applicants: Fernando ARRUDA, Essenheim (DE); Matthias PLANTE, Gorssel (NL)

(72) Inventors: Fernando ARRUDA, Essenheim (DE); Matthias PLANTE, Gorssel (NL)

(21) Appl. No.: 17/432,829

(22) PCT Filed: Feb. 21, 2020
(86) PCT No.: PCT/DE2020/100128

§ 371 Date: Aug. 20, 2021

(30) Foreign Application Priority Data
Feb. 21, 2019 (DE) 10 2019 104 466.9

(51) Int. Cl. G01B 11/275

(52) U.S. Cl. CPC G01B 11/2755; G01B 2210/143; G01B 2210/146; G01B 2210/303; G01B 2210/16

(57) ABSTRACT

An apparatus for chassis measurement for determining the alignment of the wheels of a motor vehicle. The apparatus includes a detachably fixed measurement head apparatus on the vehicle wheel to be measured, wherein the measurement markings are positioned parallel to the front and rear side of the vehicle or the vehicle stand level. After arranging the fastening apparatus and positioning the measurement markings, the laser light source is activated and a plane is projected in space, wherein the length of these laser light lines generates at least intersection points together with the measurement markings, the intersection points of which are detected as track gauge and used for computation in order to determine the fall, trailing and spread data and the virtual longitudinal travel axis of the vehicle. By a camera-assisted measurement value detection apparatus, different electromagnetic spectra for each wheel to be measured are detected and supplied for data processing.

The invention refers to a method and a device for chassis measurement according to the generic terms of Claim 1 and Claim 11.

The correct alignment of the individual wheels of a vehicle has a decisive influence on the driving and wearing characteristics of the vehicle. This is the reason why the vehicle manufacturer defines the correct alignment of the wheels in the form of nominal values.

For the front axle, the vehicle manufacturer usually defines the alignment values of individual toe angle, total toe angle, toe difference angle, camber angle and castor angle as nominal values. For the rear axle, the vehicle manufacturer usually defines the alignment values of individual toe angle, total toe angle and camber angle as nominal values.

The total toe angle of a vehicle axle is determined from the difference between front and rear distance of the wheels of the respective axle as measured on the rim flanges (outside diameter of the wheel), wheel hubs, wheel hub mount or set-up wheel on the level of the horizontal wheel middle plane. In this connection, toe angle generally means the angle between the longitudinal central axis of the vehicle as projected on the road way and the line of intersection between wheel middle plane and road way plane.

Therefore, such chassis measurement is expedient before and after the replacement of vehicle wheels with new tyres. Moreover, for example vehicles involved in a road accident are subjected to repair which generally also includes repair work on the car body. Similar measures may also become necessary due to damage caused by potholes or chassis conversion, exchange of components and other repair work.

In practice, the actual values of the above-mentioned alignment values often deviate from the nominal values for several reasons (e.g. maladjustment, component wear, kerb contact, road accident, etc.). Then, the deviations usually entail adverse effects on road safety, driving dynamics, travelling comfort and component wear.

Following the repair of the damage, body repair specialists often need to take the vehicle to a repair shop equipped with devices for measuring and correcting the alignment of the wheels of the vehicle since the wheels of a vehicle damaged in an accident usually lose their alignment. Such alignment measuring and correction instruments usually are only available at tyre specialists or tyre repair shops due to the high acquisition costs. Following the repair of the damaged vehicle, the specialized dealer therefore is frequently forced to spend time and money to move the vehicle from his own repair shop to a specialized repair shop equipped with measuring equipment in order to measure and correct the alignment of the wheels.

Thus, it is expedient or necessary in many of the cases to check the alignment of the vehicle wheels as to correspondence to the nominal values defined by the vehicle manufacturer. For this purpose, there do already exist various inventions and commercially available products. All of these known applications, however, have various disadvantages.

Since the subject of chassis measurement is of fundamental relevance in vehicle engineering, there is no lack of publications of technical solutions to describe improvements of methods and devices. Therefore, known solutions shall be looked at in detail below so that the new method and the related device can be clearly delimited.

From the publication U.S. Pat. No. 5,675,408 A, there is known a method for measuring a vehicle chassis that comprises the following steps: arrangement of the vehicle on rollers, mounting of light-beam projections means or camera devices on each wheel of the vehicle which emit light beams in one line in opposite directions and approximately at right angles to and on the same level with the rotational axis of the wheel, arrangement of interacting scales at various places in longitudinal direction of the vehicle and in the path of projection of the light beams or camera devices, activation of the light-beam projection means or camera devices and turning of the wheel on rollers so that the opposite beams or camera devices respectively allow a reading on the corresponding cooperating scales and use of the collective readings on said scales for calculation of the toe-in or toe-out wheel angle after compensation of the deviation of the light beam from the vertical to the rotational axis of the wheel.

In terms of construction, light-beam projection means or camera devices for measuring the wheel angle are firmly mounted on the wheels of the same axis of the vehicle so that they can be rotated with the wheels with the light beams or the camera axis, respectively, standing approximately at right angles to and on the same level with the rotational axis of the wheel. There are provided means for rotating the wheels by 180 degrees in the form of roller blocks on which the vehicle must be positioned for the measurement. At least two pairs of scales are provided at various positions in longitudinal direction of the vehicle in front of and behind the vehicle for the projected light beams in order to generate a double set of readings for determining the differences between the front and rear readings at a first wheel position and at a second wheel position after a 180-degree turn of the wheel, the readings of both positions being used to determine the degree of deviation of the light beams from normality to the rotational axis of the wheel and said deviation being used to correct the toe-in-in and toe-in-out wheel angle which compensates the deviation of the light beam from the vertical to the rotational axis of the wheel. Here, the scales are arranged above and at right angles to the driving plane directly opposite to one another.

This results in the following detrimental effects for that method. On the one hand, a vehicle must be positioned on anti-friction plates or pairs of rollers so that it can be measured, which requires a specifically shaped measuring set-up equipped with respective devices. Moreover, holders for the light-beam projection means or camera devices must be fixed at least in pairs on the wheels of an axle in such a manner that they can freely rotate around the wheel axis. Thus, there are needed at least two mounting fixtures with light-beam projection means or camera devices that are rotatably mounted on the wheel, i.e. that must be arranged in a freely floating manner. The rotation is required to allow for multiple readings on the scale in different orientations of the wheel so that a mean value of the reading can be determined. Furthermore, the scales must be arranged in front of and behind the vehicle more or less on level with the wheel axes in such a manner that they can be met by the light-beam projection means or camera device or can be read, respectively.

As a result, that is a solution that generates measuring values by a multi-stage method and with considerable constructional expenditure. Moreover, the rotation of the light-beam projection means or camera devices on the wheels forms a significant deficiency of the method because an improper arrangement on the wheels or constructional deviations in the holders may result in inaccuracies in the measurements. In particular swinging the light-beam projection means or camera devices on the wheels forms a significant source of error.

From the printed publication WO9219932A1, there is known a system for measuring the wheel alignment of a vehicle comprising a holder mounted on the outside of each individual wheel or pair of wheels of the vehicle. The holder is provided with a stud that coincides with the rotational axis of the respective wheel with a laser projector being mounted on the stud. It shall alternately illuminate at least two measuring scales at the respective ends of the vehicle which extend at right angles to the longitudinal axis of the vehicle. Each measuring scale consists of an optoelectronic detector unit that provides information about the exact position of the impinging light beam on the measuring scale.

For collecting the measuring values, a stand is arranged at right angles to the longitudinal centre line of the vehicle at the respective ends of the vehicle. On each stand, there is mounted a pair of continuous self-centring measuring rods that can take various lateral positions relative to the centre line of the vehicle, said lateral positions depending on the vehicle width. At the ends of the respective measuring rods, there are provided lateral measuring scales that are at a distance to the vehicle sufficient to get, from scale to scale, an unobstructed outward view from the outsides of the wheels.

To determine the angular position of the rotational axis to the centre line of the vehicle, a laser projector is pivotably borne on the stud on the holder and can be turned on the stud in order to beam alternately at each measuring scale. When the measuring scales show the same value one below the other, the rotational axis of the wheel is at right angles to the centre line of the vehicle.

This shows clearly that, for performing that method, the arrangement and orientation of the measuring scales is related to the real centre line of the vehicle. The measuring scales must be placed at right angles to the rotational axis of the wheel on measuring rods which in turn must be fixed to a stand to be arranged in relation to the longitudinal centre line of the vehicle at both ends. Since for measuring the rotational axis of the wheel, the measuring values of the front and rear scales are compared with each other and their deviations from an equal value shows the positive or negative toe value, these scales must be exactly aligned so that, with a rotational axis in parallel to the centre line of the vehicle, the same value is shown on the scales.

Therefore, considerable efforts are required for the exact positioning and adjustment of the measuring scales. Moreover, the laser projector is rotatably borne on the studs on the holder and must be turned on the stud in order to beam alternately at each measuring scale and generate measuring values. Thus, there result the same sources of error as described above due to the process of rotation of the laser projector on the holder on the wheel. Furthermore, it is of disadvantage that that measuring method is time-consuming.

The disclosure of US 2012/0313337 A1 refers to a correction of the toe angle of wheels mounted on a rigid rear axle or on a trailer axle casing in order to reduce rubbing wear on those axle wheels. There is used a laser alignment system for aligning both, the front wheels and the wheels mounted on an axle having a rigid axle casing, by arranging a laser on each of the vehicle wheel spindles or hubs. The lasers are directed at targets with measuring scales for measuring the wheels and aligning them correctly.

Front and rear laser holding devices are mounted on a vehicle front or rear wheel spindle or hub for holding a laser. During the alignment of the wheels and axles, lasers are mounted on all four wheels of the vehicle. The front measuring scale is mounted in front of the vehicle and a rear measuring scale is mounted at the rear end of the vehicle. Each target has a number of target gradations at which the light beam of the lasers is directed. During the laser alignment of the vehicle wheels, the front wheels are aligned to toe angle.

That way, the use of a laser alignment system using lasers and targets allows for a more exact alignment of the front and rear wheels of the vehicle, wherein the focus of that disclosure is not on that measuring method, but on the method for adjusting the toe angle of wheels mounted on a solid axle after the measurement has been completed. The measuring method is not explained in more detail, but reference is made to U.S. Pat. No. 6,823,598 B1 which, however, does not disclose a measuring method either, but a laser holding device as it is also used in US 2012/0313337 A1.

Accordingly, also that solution involves the disadvantage that it primarily uses a laser mounting system in which a plurality of adapters can be fixed to a stud for various vehicles with different wheel configurations. It is a constructionally expensive method for arranging a laser module on the wheel in a firm and freely floating manner and at a distance to the wheel so that it can rotate with the wheel. The measuring markings are to be positioned in front of and behind the vehicle, wherein they must be provided on all of the e.g. four wheels of the vehicle. Moreover, the alignment of that disclosure is limited to an application on structures with rigid axles.

The publication DE 10 2010 044 928 A1 in turn describes a holding device of an axle measuring head arrangement on a vehicle wheel comprising a pedestal that is fixed on a plate forming a contact area of the vehicle wheel and which has a support on the upper end of which the suspension frame with axle measuring head arrangement is provided. The fixing means for the axle measuring head arrangement comprise three edge finders connected with the main body and contacting the rim or the tyre wall of the vehicle wheel. The edge finders are pressed by a gravity moment against the rim or the tyre wall of the vehicle wheel.

It is of advantage here that, in contrast to the described solutions of the prior art, there is not used a fixed arrangement of the axle measuring head arrangement on wheel or rim by means of clamping or screwing, while it is of disadvantage that the vehicle needs to be driven onto the device via an integrated ramp. In turn, that requires an exact alignment of the devices for placing the vehicle as exactly as possible on the for example four pedestals before the axle measuring head arrangement can be placed on the wheels. It is moreover necessary to provide such device for each wheel of the vehicle because a measurement of an individual wheel is not possible due to the inclined position caused by only one pedestal.

Further disadvantages result from the fact that an exact central positioning of the wheels on all of the four pedestals is hardly achievable which is why it is provided as compensation to fix the measuring column in a laterally shiftable manner on the turning-shifting plate. The required adjustment of the measuring column, however, gives rise to fear measuring errors caused by improper application as well as also basically due to the fact that it is a turning-shifting plate. An alignment as rigid and unchangeable as possible of the axle measuring head arrangement on the wheel cannot be achieved that way.

From the published disclosure DE 20 2007 000 490 U1, there is known a motor-vehicle toe measuring device in which measuring units composed of a horizontal and a vertical measuring plate are mounted on the wheels of the front and rear axles. Then, measuring points between the wheels are determined by means of distance measuring devices so that there result two measuring points before and behind a tyre to each wheel axis on the basis of which the toe alignment of the wheels is determined. That is a toe measurement method that should involve a not insignificant measuring error and therefore is only able to deliver unsatisfactorily exact results.

The disclosure De 10 2006 026 513 B4, on the other hand, shows a device for fixing an axle measuring head arrangement on a vehicle wheel that, unlike the publication mentioned above, provides for clamping on the vehicle wheel itself. Using mechanical components, a laser beam source is clamped by holding arms on the wheel of a vehicle to be measured.

A similar solution is also disclosed in the publication EP 1 248 094 A2 which describes an axle measuring support for fixing a measuring head to a vehicle wheel. It is the basic idea there that contact pins can reach through holes or spaces in the rim in order to get in contact with a brake disk arranged behind the rim. That shall guarantee an exact reference plane for a parallel holder of the axle measuring support.

In the publication GB 2 428 808 A, there is disclosed a toe measuring device providing for a clamping of a measuring element laterally on the vehicle frame, wherein a column-shaped section extends vertically on that holder and measures the distance to the opposite wheel of the same axle. The measurement is made above wheel level and car body by means of an optical distance measurement.

The publication WO 2018/046222 A1 discloses a wheel adapter wherein there are provided, for mounting a measuring element on the vehicle wheel, at least two arms by means of which the holder can be fixed to the vehicle wheel.

In order to be also in a position to offer axle measurement, some specialized repair shops purchase such instruments and arrangements for axle measurement and alignment. However, it is obvious that such decision causes considerable expenditure for the purchase of the necessary instruments and moreover requires an own space for arranging such instruments within a repair shop.

In the following, some disadvantages of the existing prior-art measuring systems shall be mentioned in bullet point form:
High financial requirements: Known chassis measuring devices have acquisition costs of up to several tens of thousands of Euro.
High space requirements: Known chassis measuring devices require several square meters of specifically equipped working space.
High time requirements: Known chassis measuring devices require a lot of time for preparing and maintaining readiness for measurement (set-up time, fitting time, calibration time, alignment of the measuring scales in parallel to one another and absolutely centred with the longitudinal vehicle axis).
Low mobility: Known chassis measuring devices have a large volume and are bulky and therefore can only be relocated with much effort.
Moderate precision: Known chassis measuring devices have a concept-related low measuring exactness. There occur unavoidable errors due to clearance and manufacturing tolerances of the rotating measuring components.
Repetitive inaccuracy: Known chassis measuring devices have a concept-related low repetitive accuracy.
High training expenditure: Known chassis measuring devices require high training expenditure in order to ensure use free from errors.
Highly concept-bound: Known chassis measuring devices mostly can only be used for certain vehicle categories (passenger cars, trucks, etc.) or concepts (sedan, SUV, etc.).

The present invention aims at providing a method as well as a device for chassis measurement that solve the problems found in the usual working practice of body repair shops.

In this connection, it is one task of the present invention to provide a method as well as a device for chassis measurement that can be used by body repair shops, engineers and mechanics without the users incurring excessive costs.

It is a another task of the present invention to provide a device for chassis measurement that is lightweight and compact and thus does not require any extensions to be permanently installed, that can be used in a portable way and for example can be transported in a case. Ideally, it should also be possible to carry it in air traffic as standard hand luggage, i.e. its dimensions should not exceed 55 cm×40 cm×20 cm.

It is a further task of the present invention to provide a method as well as a device for chassis measurement that can be used easily, quickly and independently of the respective vehicle concept, with higher measuring precision and exactness, but still at lower operating costs as well as with high operating flexibility.

This objective and these and other tasks that will become more apparent below will be achieved by a method for chassis measurement according to Claim 1, wherein the dependent Claims 2 to 10 comprise advantageous developments of this method.

The device for chassis measurement according to the invention is claimed in Claim 11, wherein the dependent Claims 12 to 20 comprise advantageous developments of this device for chassis measurement.

The subject matter of the invention is the respective method for performing a toe measurement. As experience teaches, a laser light source is to be fixed with a mounting device on the outside of the vehicle wheel, a laser projection being applied to generate a point of intersection with a measuring marking. These points of intersection are to be read in order to determine the distance between the points of intersection this way. In a last process step, there are determined by way of calculation the longitudinal vehicle middle plane or the geometric driving axis as well as the angle of the individual wheels to said longitudinal vehicle middle plane, whereby the individual toe values are determined by calculation.

Here it is the fundamental idea of the inventive solution to position a laser light source laterally on the vehicle wheels, wheel hubs or set-up wheels in order to generate this way laser markings on the roadway plane or a plane in parallel to it that simultaneously project, on measuring markings arranged in front of and behind the vehicle, points of intersection which provide information on the distances between the points of intersection and allow to read them. Based on these distance measurements between the points of intersection on the measuring markings, it is possible to determine, in relation to the longitudinal vehicle middle plane or geometric driving axis, respectively, the angle of the individual wheels to the longitudinal vehicle middle plane or geometric driving axis by way of calculation. Here, the toe values are determined as the difference between the front and rear scale values using trigonometric functions.

It is provided here to generally use a laser light source able to generate clear points of intersection simultaneously on the positioned measuring markings. These measuring markings herein shall be arranged on the vehicle floor plane itself because the measuring markings lie flatly with minimum technical effort and thus the points of intersection are also directly generated and also read on the vehicle ground plane. Regarding the alignment of these measuring markings, there is no need for an exact alignment in relation to the vehicle body because the geometric driving axis of the vehicle is determined by calculation by collection of the measuring points on the vehicle wheels themselves. The scales do not need to be absolutely straight and parallel to one another. A parallelism error of up to +/−10 cm is acceptable. Moreover, the scales may also be laterally shifted against each other by up to 50 cm without having a detrimental effect on the exactness of the measurement.

It has turned out to be an essential improvement within the meaning of a simplified measuring method to use as light source a laser that, bearing against the vehicle wheel, the wheel hub or the set-up wheel, projects a line on the roadway plane in parallel to the vehicle-wheel middle plane. This way, a point of intersection can be read on measuring markings placed for example in front of and behind the vehicle and arranged crosswise to the longitudinal vehicle middle plane. To this end, it is only necessary to put down these for example measuring rods in front of and behind the vehicle and to read the points of intersection projected on the driving plane on these measuring rods. This way, easy reading as well as easy arrangement of the respective measuring markings is possible.

This forms in particular an essential improvement compared to methods where a movable laser measuring head is mounted on the vehicle wheel because, on the one hand, there is avoided a movement of the laser head in the sense of a rotation around the wheel axis as it is frequently provided in the prior art in order to generate several measuring points to determine a mean value. This is of disadvantage because measuring errors are advanced due to the rotation already. Moreover, it involves additional efforts for the generation of the measuring markings as well as for their reading.

The method according to the invention has the advantage to lean the measuring head against the wheel without complex mounting by a mobile device, which is also made possible by the fact that actually there shall be no rotation because, with a single projection of the laser line on the vehicle floor plane, all required measuring markings are already generated and can be read in a single process step. This way, the required distance measurement between the determined points of intersection and therefore also the calculation in relation to the longitudinal vehicle middle plane can be performed in a clearly quicker and simplified manner.

According to the invention, the laser light source of the measuring head unit generates, for each axle of the chassis to be measured and/or for each wheel of the vehicle to be measured, laser light of a different electromagnetic spectrum and/or of a different frequency modulation, for example by using filters that generate or convert white laser light in different colours, free-electron lasers, lasers working in whispering gallery mode (WGM), and other technical laser modulation methods that are known or still under development. A camera-based measuring value acquisition unit detects these measuring markings and automatically transmits them to data processing in a manner assigned, according to the detected laser light of a defined electromagnetic spectrum, to a wheel and/or an axle of the vehicle associated to that spectrum. This makes it possible to clearly assign the measuring values of the different wheels by means of the laser light of different electromagnetic spectra and, on the one hand, to reduce measuring errors and, on the other hand, to simplify and accelerate the measurement this way.

Basically, different technical solutions are applicable for the measuring markings. As already shown, it would be for example expedient to use measuring markings in the form of measuring rods having for example a scaling that allows for easy reading of the points of intersection on these measuring rods and also a determination of the distance.

At this point, however, it is to be said that many alternative possibilities can be used for detecting the points of intersection in an optically readable manner on the measuring rods. For example, scaling cannot only be applied in usual forms, but for example also in the form of coding or colour coding that allows, apart from reading with the human eye, also reading by technical aids.

According to the method, the reading of the measuring markings and of the points of intersection generated thereon with the laser markings is made assisted by a hand-held measuring instrument or through a special software application by means of a device for electronic data processing (e.g. computer, smartphone, or the like). Apart from the most simple form of manual entry of the data in an application, it is possible this way to acquire the laser markings automatically by means of a camera-like optical sensor. Especially for this form of a technical solution, a variety of types of scaling is applicable in order to achieve a simplified reading of the laser marking on the measuring markings.

The measuring marking can be realized using different designs. As an alternative, tape measures or retractable tape measures as well as multiple folding rules are applicable. But a measuring marking can also be permanently applied on a surface at a repair shop, for example in the form of a coating that can be applied as direct paint coating or also as a foil stuck or put on floor or wall. It is only a central requirement that the reading of the measuring markings can be made in an automated manner. This can also be done with a coded measuring scale that cannot be read directly by the user, but only with a reading unit. In the simplest case, the colour-coded scale is directly read by the user and entered into the hand-held unit.

According to the invention, the mounting unit for arranging a laser light source on the vehicle wheel, the wheel hub or the set-up wheel can consist of a horizontal base to be freely placed on the vehicle floor plane interacting with a wheel-contact body, wherein at least one support arm connects the wheel-contact body with the base so that a gravity moment causes the wheel-contact body to be leaned against the rim of the vehicle wheel. Accordingly, use is made of the inclination by which the support arm leans the wheel-contact body against the rim. This way, it is ensured that no measuring errors are caused by improper clamping of the mounting unit on a vehicle wheel or on its rim, respectively. Mounting means in the usual form, e.g. in the form of clamping elements are not required here.

It may also be of advantage here that the wheel-contact body disposes of arms of a length-adjustable design by which bearing against the rim or the wheel flanks by means of support bodies is possible. This way, the support bodies can be adjusted by the length-adjustable arms in such a way that they come to lean against the rim or the wheel flank at suitable points. As an alternative, an arrangement directly and in parallel at a certain point on a set-up wheel or a comparable unit is possible.

The measuring inaccuracy in the toe angle measurement known from customary solutions is practically completely eliminated by the innovative solutions of the present new invention. With a perfect condition of the device, a possible remaining measuring inaccuracy therefore is always caused by an error of the user, but never by the device or the method.
a) In most of the customary solutions, the wheel-contact body is mounted on the wheel by means of clamping. Clamping leads to a measuring inaccuracy not to be neglected. In the present invention, the wheel-contact body is mounted on the wheel without any clamping. With the abandonment of clamping, the measuring inaccuracy is completely eliminated.
b) In most of the customary solutions, a separate wheel-contact body is used for each individual wheel of the vehicle. In the present invention, however, altogether only one wheel-contact body is used. This wheel-contact body is successively used on all wheels of the vehicle. Since the wheel-contact body is mounted on both wheels of an axle respectively rotated by 180° (around the z-axis), any possible measuring inaccuracies—caused by the wheel-contact body—will compensate each other on the left and on the right wheel of an axle. Thus, the respective measuring inaccuracy is completely eliminated.
c) In most of the customary solutions, the geometric driving axis is inadmissibly neglected in the determination of the toe angles. Instead of it, those solutions refer to the longitudinal vehicle middle plane. In the present invention, an alignment of the measured toe angles is made taking the mathematically exactly calculated geometric driving axis into account:
   1. Determination of the position of the individual wheels in relation to the scale reference system.
   2. Mathematical determination/calculation of the geometric longitudinal axis of the vehicle.
   3. Calculation of the individual toe values (all wheels, front axle and rear axle) in relation to the geometric longitudinal axis of the vehicle.
   4. Calculation of the rear axle angle.
   5. As an alternative to the longitudinal axis of the vehicle, conversion of the toe values in reference to the rear axle.

A method for automated reading by means of a camera arranged on the vehicle roof or at another position in the room is of advantage as well. Accordingly, there is provided the linking of a camera with its electronic control and the laser projectors mounted on the vehicle wheel, wherein advantageously projection takes place on all wheels at the same time. Herein, the camera is able to recognize and assign the projection per wheel. This works ideally by a switching-on of different laser light colours and/or wavelengths of the laser light per wheel and/or by short switching-on and -off of the laser light source per wheel, which is recognized in relation to time by the camera so that the reading unit can assign the points of intersection on the measuring markings to the respective wheel and axle and captures all wheels in a single reading process. It is the advantage of this solution that the reading can be made in an automated way without involvement of the user. To this end, however, it is also expedient that the laser light sources are arranged on all of the 4 wheels at the same time in order to simultaneously read the intersection lines of all wheels and transmit them to a unit for electronic data processing (e.g. computer, smartphone, or the like) which correspondingly calculates the toe position.

As an alternative to using 4 laser light sources at the same time, it is possible to work simultaneously for example with 2 laser light sources with green and blue light, wherein green is used for the front axle and blue for the rear axle. Thus, on the left and on the right sides of the vehicle, the procedure is the same. This is also possible in combination with automatic camera detection of the measuring markings, wherein even wavelengths within the infra-red region invisible to the human eye can be applied. Here as well, it is provided that the laser source shortly switches on and off per wheel so that the reading unit can assign the points of intersection on the measuring markings to the respective wheel and axle and captures all wheels in a single reading process.

As an alternative to the use of 4 or 2 laser light sources at the same time, it is also possible to work with 1 laser light source, wherein the reading unit can assign the points of intersection on the measuring markings to the respective wheel and axle and captures all wheels in a single reading process.

This camera-like reading unit expediently disposes of a holding and adjustment device by means of which it can be arranged e.g. on the vehicle roof. This way, the unit can read all of the 4 points of intersection in front of and behind the vehicle in a single working process. This device can be designed as kind of a small stand or tripod so that the camera can be adjusted as to its height and angle in such a manner that both measuring markings are simultaneously covered.

At this point, the aspect which kinds of scaling are arranged on the measuring markings is of relevance, too. It is provided here to arrange laser light sources with different electromagnetic spectra on the front and rear axles whereby the camera-like reading unit can detect on the basis of these different electromagnetic spectra of the laser light whether the front or the rear axle is concerned. This way, all measuring points, for the front and rear axles altogether at least 8 points of intersection on the measuring markings, can be read in a single working process.

As electromagnetic spectra of the laser light, at least the regions of visible right as well as also of ultraviolet and infra-red laser light can be used.

The user-practical solution of reading of the measuring markings by a camera, however, does also show an advantage of the simpler variant without such camera reading. When doing without the camera acquisition of the measuring markings, it is possible to measure an entire vehicle as to its toe position with only one mounting unit and one laser light source. This can be explained by the fact that the respective measurements of the points of intersection on the measuring markings are made individually for each wheel of the vehicle and the points of intersection can be read successively.

This has the advantageous effect that possible measuring errors that for example may be caused by the mounting unit of the laser light source on the vehicle wheel will offset each other as measuring error because, with only one mounting unit and laser light source, such measuring errors logically will be the same on every wheel and therefore will be offset again in the overall calculation. It results from the above that successive measurement of the individual vehicle wheels with the same vehicle toe measurement unit will show very exact results because possible inaccuracies of the mounting unit will not be reflected in measuring errors.

A further basic improvement can be achieved by assigning to each vehicle wheel a ramp-like wheel support in which pairs of rollers are rotatably borne. In a housing frame, the bearings of the pairs of rollers are in an elevated position so that they are freely rotatable and the vehicle is borne on the wheel support in a slightly elevated position. In particular in combination with the above-described wheel supports and a possibly automated rotation of the vehicle wheels for considering the rim run-out, the exactness of the result is increased. To this end, the vehicle is to be borne on the wheel supports in a first step so that the wheels are freely rotatable so that several measurements can be made without moving the vehicle.

This way, the vehicle can be driven on said wheel support, which allows turning the vehicle wheels during the measurement. It is the aim of this improvement that the rim run-out can also be taken into consideration in the measurement of the toe position by turning the vehicle wheels e.g. by 90° and measure them several times. Thus, errors can be calculated out here as well.

In a further development of this basic idea, it is provided that an electric motor with electronic control operates said wheel supports and the pairs of rollers arranged therein. According to the invention, such unit could interact with the camera-like reading unit on the vehicle roof, wherein it is achieved, e.g. with a combination of signals, that 4 measurements with vehicle wheels turned on by 90° each time are automatically made via the reading unit arranged on the vehicle roof and thereby the rim run-out can also be taken into consideration in the calculation. Apart from the vehicle roof, other positions of the camera-like reading unit are possible as well, as for example on the ceiling or wall of a repair shop.

An advantageous embodiment of the device for chassis measurement moreover includes an inclination protractor sensor for detecting the camber angle. After positioning and adjustment of the device on the wheel to be measured, the camber angle can be read and for example transmitted to data processing. This additional sensor furthermore can serve to measure the castor angle, which is explained in more detail below. Advantageously, the device is designed as a compact kit comprising all components of the device, all components of the device being transportably accommodated in a mobile container approved as hand luggage in air traffic.

In an embodiment, the device moreover includes a template for castor angle measurement which is positioned beside the wheel to be measured and on which the projected laser markings in defined steering positions of the wheel to be measured can be read. According to the invention, said template for castor angle measurement has at least markings that allow for a positioning of the template by the projected laser marking in the straight-ahead position of the wheel to be measured as well as define, for measurement of the camber angle on the inclination angle sensor, the wheel position with 10° left angle steering as well as 10° right angle steering of the wheel to be measured. 10° are typical here, but it can also be done using a different angle, such as 15° or 20°.

In the application method, the measurement process is as follows—after positioning of the measuring device e.g. on the rim flange of the wheel to be measured, the template for castor angle measurement is, in the straight-ahead position of the wheel, positioned beside the wheel according to the projected laser marking beside that wheel by means of a first central marking.

In a first step, the steering wheel then is turned to the left until the projected laser marking runs parallel to a first 10° marking extending to the left on the template for castor angle measurement. The camber angle at a left angle steering of 10° is read on the display of the inclination angle sensor and can for example be entered into data processing.

In a second step, the steering wheel analogously is turned to the right until the projected laser marking runs parallel to a second 10° marking extending to the right on the template for castor angle measurement. The camber angle at a right angle steering of 10° is read on the display of the inclination angle sensor and can for example be entered into data processing. Herein, the angle can also have a value other than 10° and the template can be designed accordingly.

In the following, the invention is explained in more detail on the basis of drawings.

The figures show the following:

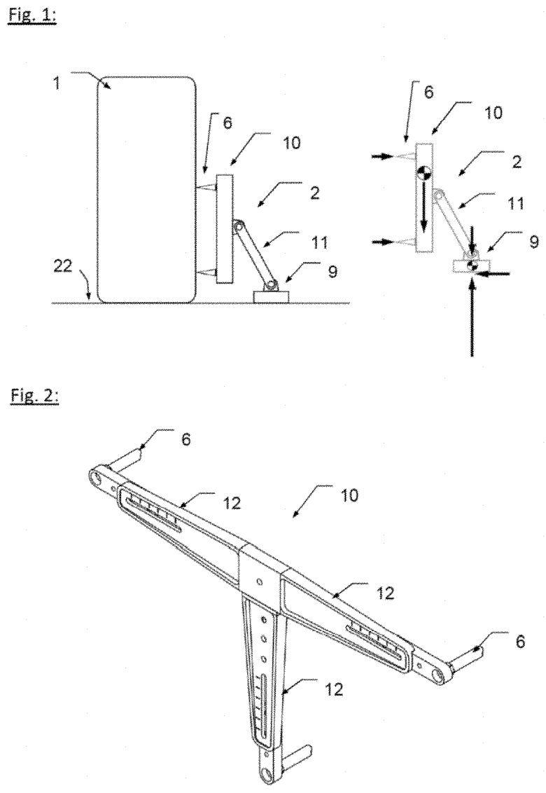

FIG. 1 shows the arrangement of the mounting unit on the vehicle wheel;

FIG. 2 shows the design of the wheel-contact bodies of the mounting unit;

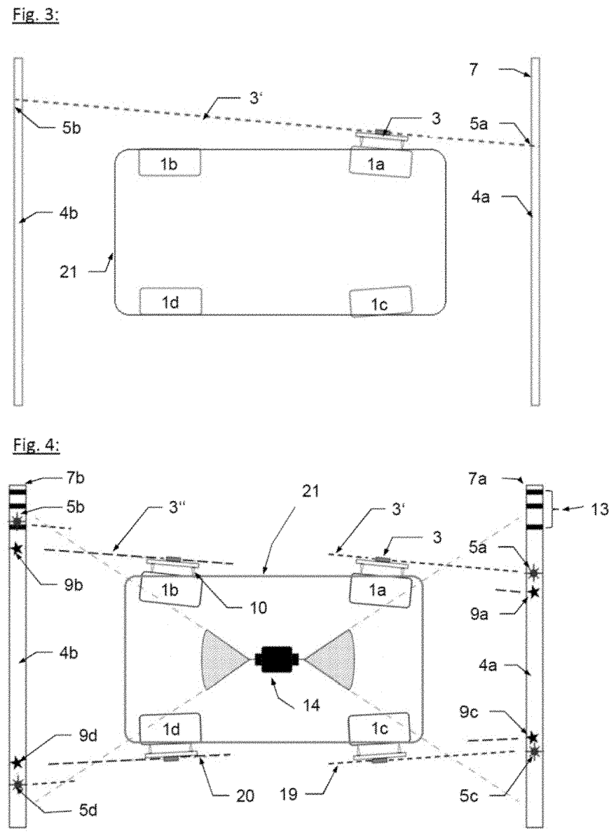

FIG. 3 shows the arrangement of the laser projection on a wheel axis with a projected laser light line on 2 measuring markings;

FIG. 4 shows the schematic representation of a camera-aided measurement of all of the 4 wheels of a vehicle on 2 measuring markings;

FIG. 5 shows the wheel support according to the invention with a vehicle wheel placed on it and the schematic illustration of the possibility of 4 measuring points staggered by 90°; and

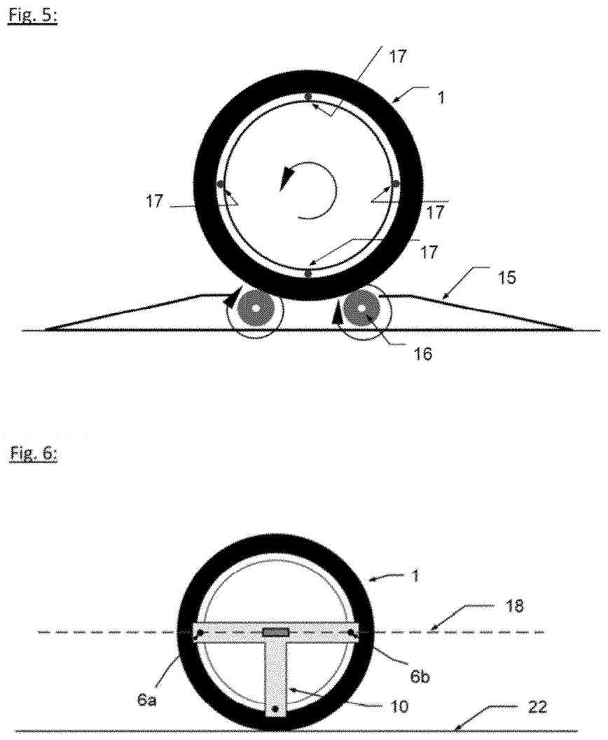

FIG. 6 shows a lateral view of the arrangement of the wheel-contact body with projection line of the laser light.

FIG. 1 illustrates how a wheel-contact body 10 is mounted on a vehicle wheel 1 via a support arm 11 extending from a base 9 to be freely arranged on the vehicle floor plane. In the lateral representation, it is clearly visible that, only by a gravity moment acting by the inclination of support arm 11 on the wheel-contact body 10, the wheel-contact body 10 is safely leaning against vehicle wheel 1. The force arrows shown on the right illustrate how the forces are respectively acting here.

FIG. 2 illustrates the arrangement of the length-adjustable arms 12 on the wheel-contact body 10 as well as the support bodies 6 extending from the arms 12, so that there is provided a wheel-contact body 10 adjustable to the respective vehicle wheel 1 or its rim, respectively. Together with the basic structure of the mounting unit 2, this supports the exactness and the hold of the measuring device on the vehicle wheel 1.

FIG. 3 is a simple first representation of the principle of the measurement. For simplification, the respective toe of four vehicle wheels (1a, 1b, 1c, and 1d) of a vehicle 21 is presented in a manner above average here. In front of and behind the vehicle 21, the measuring markings 4a and 4b are arranged more or less parallel to the front and rear sides of the vehicle, an exact alignment not being required. With this basic arrangement of the measuring markings, it is possible to determine the longitudinal vehicle middle plane with the laser projection 3′ from the points of intersection 5a and 5b resulting on the measuring markings 4a and 4b.

The presented design is a solution in which a measuring head unit with laser light source 3 forms a laser area projecting, on the roadway plane, the laser line 6′ indicated as a dashed line that intersects the measuring markings 4a and 4b in front of and behind the vehicle. For simplification, no scaling 13 is drawn on the measuring markings 4a and 4b.

The more elaborate solution with automated measurement can be seen in the following FIG. 4 in which a camera-like reading unit 14 is schematically presented centrally on the vehicle. Basically, other positions on or beside a vehicle are applicable for this purpose as well. From this camera-like reading unit, there extend, as indicated in a certain angle, the readings on the front and rear sides that can access the measuring markings 4 within a certain angle, in the exemplary representation smaller than 90°.

The measuring markings 4a and 4b, for example measuring rods 7a and 7b, are located in front of and behind the vehicle as in the preceding figure, wherein it is schematically indicated that, in the measurement of all wheels, different points of intersection, namely four points of intersection 5a, 9a, 5c and 9c on the front measuring marking 4a and another four points of intersection 5b, 9b, 5d and 9d on the rear measuring marking 4b, are generated by the laser projection and that all of said points of intersection on the measuring markings 4a and 4b can be simultaneously captured by the camera-like reading unit 14.

An especially advantageous inventive solution provides to make use of different laser light frequencies for being able to assign, in an automated manner, the points of intersection 5a and 5b to the respective vehicle wheel 1a, the points of intersection 9a and 9b to the respective vehicle wheel 1b, the points of intersection 5c and 5d to the respective vehicle wheel 1c, and the points of intersection 9c and 9d to the respective vehicle wheel 1d. This is graphically represented in such a way that the laser projections 3′ of differing laser frequency are shown by differently dashed lines 19 and the laser projections 3″ of differing laser frequency by differently dashed lines 20. The points of intersection of these differing laser light markings are represented by different forms of stars on the measuring markings 4a and 4b.

FIG. 4 illustrates by the arrangement of the points of intersection how the deviations relevant to toe measurement can be read. The points of intersection and their distances to one another are different on measuring markings 4a and 4b in front of and behind the vehicle, wherein the measurable line or distance deviations of these points of intersection can be used for the determination by calculation. Thus, the points of intersection with the measuring markings 4a and 4b can also be transmitted to an evaluation unit, for example on a unit for electronic data processing (e.g. computer, smartphone, or the like). Basically any computer is suitable for the respective data processing, such as PC, smartphones, tablets, and also future data processing units.

Thus, the points of intersection 5a, 5b, 5c, 5d, 9a, 9b, 9c and 9d with the measuring markings 4a and 4b can also be transmitted to an evaluation unit, for example on a unit for electronic data processing (e.g. computer, smartphone, or the like). Basically any computer is suitable for the respective data processing, such as PC, smartphones, tablets, and also future data processing units.

As an alternative, it can also be provided to perform the calculation of the toe position via a central data server application, which is why in such case the measuring data are transmitted e.g. by a smartphone to such central calculation database and, after calculation, they are transmitted back e.g. to the smartphone. Basically, there are various possible ways how and by what devices the actual computational calculation of the toe position on the basis of the measured data finally can be carried out.

The following FIG. 5 shows a wheel support 15 with a vehicle wheel 1 placed on it. Here, pairs of rollers 16 are visible on which a vehicle wheel 1 rests and is freely rotatable. 4 markings are shown on the vehicle wheel 1 to illustrate that for example 4 measurements respectively offset by 90° can be easily realized by the arrangement on the wheel support 15.

FIG. 6 finally shows a wheel-contact body 10 on the vehicle wheel 1 in a lateral view. It is visible here that the wheel-contact body 10 has a three-point support on the vehicle wheel 1, which is also technically of advantage to ensure a safe leaning of the wheel-contact body 10 against the vehicle wheel 1. Since a plane is always positively defined by at least 3 points, this optimized solution ensures that the wheel-contact body 10 always takes an orientation parallel to the wheel middle plane. With the help of a spirit level installed in the measuring head unit with laser light source (3), it is ensured that the upper two support bodies 6a and 6b always are on a line 18 parallel to the vehicle floor plane 22. By leaning against the metallic wheel rather than against the flexible tyre, elasticity-related measuring inaccuracies are eliminated in addition.

Finally, it shall be elucidated that it is the aim of the present invention to provide the user with a fully integrated solution (device & method) for chassis measurement which combines the advantages of known solutions and at the same time eliminates their disadvantages. The invention allows an extremely user-friendly chassis measurement on most different vehicle categories with wheels, such as e.g. passenger cars, trucks, agricultural machines, construction machines, commercial vehicles, trailers, aeroplanes, etc.

The invention addresses professional users from the fields of vehicle development, vehicle testing, vehicle maintenance, vehicle repair, vehicle distribution, vehicle rental, car-fleet attendance and professional motor sport. Beyond the above, the invention in particular also addresses private users from the fields of modern classic cars hobby, vintage cars hobby, vehicle restoration, vehicle modification (tuning), amateur motor sport and amateur sport aviation.

1. A method for chassis measurement using a device for chassis measurement comprising a measuring head unit arranged on the vehicle wheel by a mounting unit comprising a laser light source for the generation of measuring points on measuring markings, wherein
for preparing the measuring process, a mounting device detachably fixes the measuring head unit to the vehicle wheel to be measured,
wherein either a wheel-contact body of the mounting unit detachably fixes the measuring head unit in a freely movable manner, but pressed against a first vehicle wheel by a support arm extending from a base,
wherein the mounting unit with the base is freely placed on the vehicle floor plane beside the vehicle wheel, the measuring head unit with laser light source being, by a screw connection, arranged in a firmly defined orientation to the wheel-contact body,
or a mounting unit of a magnetic design detachably fixes the measuring head unit, aligned at right angles to the vehicle floor plane and parallel to the wheel middle plane, directly to the wheel hub, wheel bolts and/or set-up wheel pressing it against a vehicle wheel,
and the measuring markings are positioned, without exact alignment, parallel to the front and rear sides of the vehicle and/or in the middle of the vehicle or in front of and behind the vehicle wheel to be measured on the vehicle floor plane without a defined fixed and/or measured distance to the vehicle body, the wheels, the wheel axes and/or the vehicle axles,
wherein the measuring markings have scales and/or numbers, letters, or colour coding that are aligned pointing upwards and/or towards the laser light source parallel to the vehicle floor plane on which they are lying,
whereupon, after arrangement of the mounting unit on the vehicle wheel and positioning and alignment of the measuring markings, the laser light source is activated and a laser area is projected in the room that is arranged at right angles to the vehicle wheel middle plane and parallel to the wheel-contact body, and
said laser area projects a laser light line on the driving plane beside the vehicle wheel,
wherein the length of said projected laser light line simultaneously generates at least points of intersection with the measuring markings,
these points of intersection being used as toe values or, with independent suspension, the individual toe values of all individual wheels of the vehicle being captured and used in calculation in order to determine the camber, castor and steering-swivel data and the virtual (geometric) longitudinal driving axis of the vehicle,
wherein, for each axle of the chassis to be measured and/or each wheel of the vehicle to be measured, laser light of a different electromagnetic spectrum and/or of different frequency modulation is generated by the laser light source of the measuring head unit and is captured by a camera-based measuring value acquisition unit being automatically assigned by the latter according to the laser light of a defined electromagnetic spectrum to a wheel and/or and axle of the vehicle related to such spectrum and transmitted to a data processing unit.

2. A method for chassis measurement using a device for toe measurement according to claim 1, wherein
in the chassis measurement, the same measuring unit comprising mounting unit and measuring head unit is successively used for all wheels for being successively arranged on all wheels of the vehicle and capturing the chassis measuring values,
wherein the area formed by the laser light source allows for the optical reading of camber values on the measured wheel with the help of a protractor vertically placed on the vehicle floor plane and into the laser light.

3. A method for chassis measurement using a device for toe measurement according to claim 1, wherein
a template for castor angle measurement is placed beside the wheel to be measured for reading the projected laser markings in defined steering positions of the wheel to be measured,
wherein, in a first step, the template for castor angle measurement is adjusted with a first marking on the projected laser marking in the straight-ahead position of the vehicle wheel to be measured,
to make then, based on a second and third marking of the template, one measurement each with a left- and a right-angle steering by the same number of degrees from the straight-ahead position of the vehicle wheel to be measured,
as well as one measurement of the camber angle each on the inclination angle sensor with a left- and a right-angle steering by the same number of degrees of the wheel to be measured,
this measurement being successively made on both vehicle wheels of an axle for determination of the castor angle by calculation on the basis of the captured measuring values.

4. A method for chassis measurement using a device for toe measurement according to claim 1, wherein
rim run-out compensation is done by a second measurement,
wherein, before the second measurement, the vehicle is rolled over the vehicle floor plane in such a way that the wheels rotate by 180° with a tolerance of +/−5° compared with the first measurement.

5. A method for chassis measurement according to claim 1, wherein
after a first toe measurement, for a compensation of possible rim run-out deviations, the vehicle wheels are further rotated on ramp-like wheel supports by defined angles of rotation and are newly measured at each of these measuring positions,
said rotation of the vehicle wheels at intervals being either made manually or by electro-motor drives on the wheel supports.

6. A method for chassis measurement using a device for toe measurement according to claim 1, wherein
the toe values or, with independent suspension, the individual toe values of all individual wheels of the vehicle are captured and the exact positions of the wheels of the vehicle in relation to each other are determined this way without a physical relation used in the measurement or a reference to the vehicle body, the wheel axes and/or the vehicle axles,
and these measuring values then are put into relation by calculation to the respective vehicle coordinate system that is firmly connected with the measured vehicle.

7. A method for chassis measurement according to claim 1, wherein
to each axle, there is assigned a device for chassis measurement with a different laser light spectrum and the measurements on the two sides of one axle are made successively with the same device,
wherein, by the identical laser light spectrum, the measurements on one axle are to be assigned to each other by the measuring value acquisition unit.

8. A method for chassis measurement according to claim 7, wherein
in case of overlapping measurements and therefore overlapping laser light markings on the measuring markings, the laser light sources generate the laser light markings by interval switching synchronized alternating between the laser light sources,
so that the measuring value acquisition units can clearly separately capture the measuring markings alternatingly generated at intervals.

9. A device for chassis measurement according to the method of the preceding claims, comprising at least an axle measuring head unit comprising at least a measuring head unit with a laser light source that is arranged on the vehicle wheel, the wheel hub, or the set-up wheel by a mounting unit, wherein
the mounting unit for the measuring head unit either comprises a support arm extending from a base on which there is arranged a wheel-contact body carrying the measuring head unit for a freely leaned detachable fixing rigidly aligned by a gravity moment on the vehicle wheel,
wherein the measuring head unit with laser light source is arranged by screw connection in a firmly defined orientation on the wheel-contact body by noses and/or recesses on the back of the measuring head unit and respectively corresponding noses and/or recesses on the wheel-contact body,
or the mounting unit for the measuring head unit with laser light source aligns the latter by a magnet directly on the wheel hub, the wheel bolt, and/or the set-up wheel at right angles to the vehicle floor plane and parallel to the wheel centre line,
wherein the device for chassis measurement comprises a laser light source that projects a laser marking as an area in the room which projects a laser light line at right angles to the vehicle wheel centre line and parallel to the wheel-contact body on the vehicle floor plane beside the vehicle, thereby generating laser light of different electromagnetic spectra for each axle of the vehicle to be measured and/or each wheel of the vehicle to be measured,
and the device for chassis measurement comprises at least two measuring markings that are designed to readably display points of intersection with the projected laser markings in front of and behind the vehicle wheel to be measured,
wherein the measuring markings have scales and/or numbers and/or letters or colour coding that are aligned parallel to the vehicle floor plane and lying on it, pointing upwards,
and the device for chassis measurement comprises a camera-based measuring value acquisition unit for the automatic acquisition and assignment of the laser light markings of a defined electromagnetic spectrum to the measured wheel and/or the measured axle of the vehicle for further data processing of the measuring values.

10. A device for chassis measurement according to claim 9, wherein
the support arm designed adjustable in length connects the wheel-contact body and the base with each other via a ball and socket joint or another at least single-axle joint so that these components always are connected with each other in a manner that is fixed, but aligning by the gravity moment so that they are designed to be optimally adjustable to the respective wheel dimension,
wherein the wheel-contact body has three length-adjustable arms with support bodies by which it is freely leaning against the rim or the tyre wall of the vehicle wheel,
wherein the support bodies are made of a material or designed with contact surfaces of a material or are coated with a material that is softer than the rim material so as to reduce scratching,
and the base is of a design secured against unintended shifting on the driving plane by frictional forces determined by a defined own weight and/or an anti-slip coating on the standing area of the base.

11. A device for chassis measurement according to claim 9, wherein
the device comprises an electronic inclination angle measuring instrument for camber measurement and a template for castor angle measurement,
the template for castor angle measurement having at least markings for positioning the template by the projected laser marking in the straight-ahead position of the vehicle wheel to be measured as well as for reading a left-angle and right-angle steering of the vehicle wheel to be measured by the same number of degrees.

12. A device for chassis measurement according to claim 9, wherein
the measuring marking is designed as measuring tape, adhesive tape, or a measuring stick of a single piece or of composable sections, a multiple folding rule, a telescopic measuring marking, or a foil-like coated surface.

13. A device for chassis measurement according to claim 9, wherein
the mobile camera-based measuring value acquisition unit has a holding and adjustment unit for arranging it on the vehicle roof of the vehicle to be measured, on a lateral part of the vehicle, on the mounting unit or the measuring head unit arranged on it or on the vehicle floor plane itself.

14. A device for chassis measurement according to claim 9, wherein
the device is designed as a compact kit comprising all components of the device, all components of the device being transportably accommodated in a mobile container approved as hand luggage in air traffic.

15. A device for chassis measurement according to claim 9, wherein
the device comprises ramp-like wheel supports,
in which pairs of rollers are rotatably borne.

16. A device for chassis measurement according to claim 15, wherein
the ramp-like wheel supports have an electric motor and an electronic control unit for a defined operation of the rotatably borne pairs of rollers.

17. A device for chassis measurement according to claim 9, wherein
the laser light source generates, by the laser line projected on the vehicle floor plane beside the vehicle wheel to be measured, simultaneously points of intersection with the front and rear measuring markings,
that are at least twice as long as the wheel centre distance of the vehicle and at least 5 to 8 metres for passenger cars and 20 to 25 metres for trucks.

18. A device for chassis measurement according to claim 9, wherein
the laser light sources are provided with an electronic control unit that, when using multiple simultaneously operated devices for chassis measurement with laser light of different electromagnetic spectra, generates the overlapping laser light markings by alternatingly synchronized interval switching so that the measuring markings alternately generated in the interval are emitted offset to each other in time.
